(19) United States
(12) Patent Application Publication
(10) Pub. No.: US 2013/0081072 A1
(43) Pub. Date: Mar. 28, 2013

(54) PREEMPTIVE VIDEO DELIVERY TO DEVICES IN A WIRELESS NETWORK

(71) Applicants: David M. ALWARD, Danville, CA (US); Lalit R. KOTECHA, San Ramon, CA (US)

(72) Inventors: David M. ALWARD, Danville, CA (US); Lalit R. KOTECHA, San Ramon, CA (US)

(73) Assignees: CELLO PARTNERSHIP, Basking Ridge, NJ (US); VERIZON PATENT AND LICENSING INC., Basking Ridge, NJ (US)

(21) Appl. No.: 13/247,185

(22) Filed: Sep. 28, 2011

(51) Int. Cl. H04W 28/06; H04H 60/32; H04H 20/71; H04W 40/00; H04L 12/26; H04W 24/00

(52) U.S. Cl. 725/14; 370/235

(57) ABSTRACT

Content may be preemptively delivered to mobile devices in a wireless network using multicast delivery techniques. In one implementation, a method may include analyzing network traffic of a number of users; determining, based on the analysis, whether a content item is a popular content item, as determined by requests for the content item from the users; and transmitting, a signal, in response to the determination, to schedule preemptive multicast delivery of the content item to mobile devices. The multicast delivery may be performed over one or more radio interfaces in which multiple mobile devices receive the content item over a shared radio channel.

### BACKGROUND INFORMATION

In an increasingly networked world, more and more traffic, such as data, voice, and video, is transmitted over public and proprietary networks. Wireless networks, in particular, are becoming increasingly popular as networks through which subscribers obtain both voice services (e.g., telephone calls) and data services (e.g., email and web surfing).

One class of mobile wireless devices, such as smartphones and tablet (e.g., “pad”) computing devices, may include mobile communication devices that are designed to provide additional functionality, such as the ability to execute a variety of general purpose computing applications. Video and video-related services, in particular, may be provided through these devices.

When providing video over a wireless network, it may be important to intelligently deliver the video to the mobile devices to limit strain on the wireless network. One known technique for streaming video is known as multicast. With wireless multicast, a single channel may be used to broadcast a video stream to multiple mobile devices. In contrast, with a unicast wireless transmission, a video stream may be transmitted over a channel that is dedicated to a single mobile device.

### BRIEF DESCRIPTION OF THE DRAWINGS

FIG. 1 is a diagram of an example environment in which systems and/or methods described herein may be implemented;

FIG. 2 is a diagram illustrating a second example view of the environment of FIG. 1;

FIG. 3 is a diagram illustrating example components of a device that may be used to implement the elements shown in FIGS. 1 and 2;

FIG. 4 is a diagram illustrating conceptual components of a mobile device relating to the operation of the mobile device in caching and presenting content to a user;

FIG. 5A is a flow chart illustrating an example process for implementing and/or maintaining a content cache at a mobile device;

FIG. 5B is a flow chart illustrating an example process for handling user requests for content at a mobile device;

FIG. 6 is a flow chart illustrating an example process for preemptively delivering multicast content to a mobile device;

FIG. 7 is a diagram illustrating an example of message communications in the situation in which content is preemptively triggered from a traffic monitor; and

FIG. 8 is a diagram illustrating another example of message communications in the environment of FIG. 1.

### DETAILED DESCRIPTION OF PREFERRED EMBODIMENTS

The following detailed description refers to the accompanying drawings. The same reference numbers in different drawings identify the same or similar elements.

Techniques described herein may relate to the delivery of content over wireless networks. The content may be preemptively delivered and stored (cached) by the user's mobile device. The content may be pre-delivered using multicast delivery in which a single wireless channel may be simultaneously received by a number of mobile devices. A later request to view the content, at a mobile device, may be intercepted by the mobile device, and presented to the user without requiring the content to be retrieved from the network.

In various implementations, a number of different triggers may be used to determine when to preemptively deliver content to mobile devices. In one implementation, content may be delivered based on traffic analysis of data traffic of users of a wireless network. In another implementation, content may be preemptively delivered based on an analysis of historical logs of a content provider or based on an explicit request submitted by an authorized content provider.

As used herein, the term “content” will be primarily described as video content. However, content, when used herein in the context of preemptively delivered data, may more generally also refer to audio content, other multimedia files, programs (such as system updates for mobile devices), sports shows or scores, web pages, or other similar type of content.

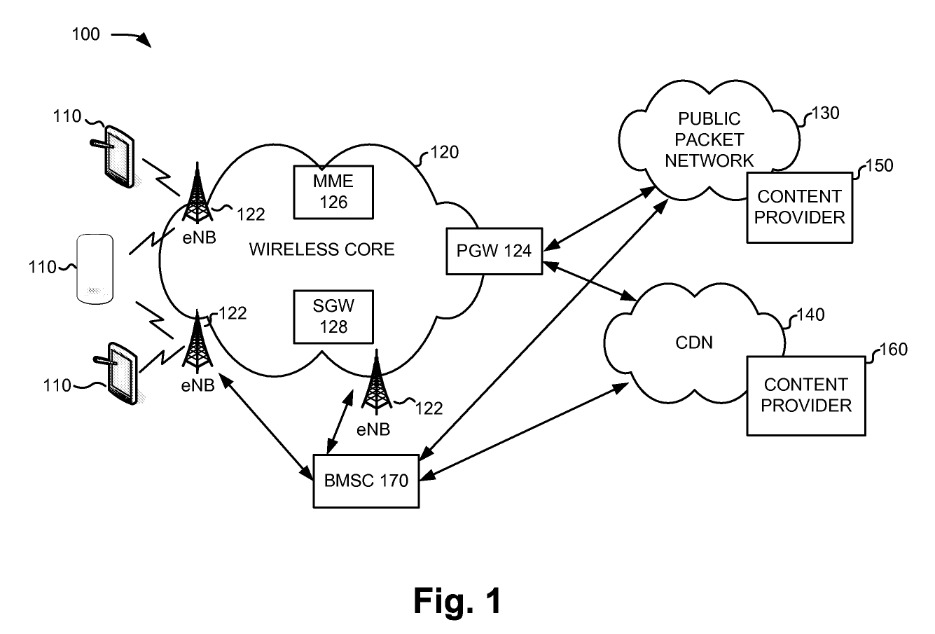

FIG. 1 is a diagram of an example environment 100 in which systems and/or methods described herein may be implemented. As illustrated, environment 100 may include mobile devices 110, a wireless core 120, a public packet network 130, a content delivery network (CDN) 140, content providers 150 and 160, broadband messaging service center (BMSC) 170. Mobile devices 110 may include portable computing and communication devices, such as a personal digital assistant (PDA), a smart phone, a cellular phone, a laptop with an integrated connectivity to a cellular wireless network, etc. Mobile devices 110 may connect, through a radio link, to wireless core 120 or MBMS-GW 170. Mobile devices 110 may obtain content from wireless core 120, store the content, and present the content to users of mobile devices 110.

Wireless core 120 may include a core network portion that provides unicasst connectivity to mobile devices 110. Wireless core 120 may represent, for example, a cellular network operated by a cellular provider. In one implementation, wireless core 120 may include a long term evolution (LTE) network that provides wireless services to mobile devices 110. Wireless core 120 may particularly include base stations (“eNBs”) 122, a packet data network gateway (PGW) 124, mobility management entity (MME) 126, and serving gatewaty (SGW) 128. Although referred to as a wireless network, the wireless portion of wireless core 120 may particularly refer to the radio interface between mobile devices 110 and base station 122. Connections between network devices (e.g., base stations 122 and PGW 124) within wireless core 120 may include wired and/or wireless connections. In general, a number of other networks devices may also be used in the implementation of wireless core 120.

Base stations 122 may provide the radio interface to transmit and receive data with mobile devices 110. In one implementation, base stations 122 may utilize LTE standards operating in a 700 MHz frequency band (i.e., base stations 122 may each be a base station in a LTE network).

Each base station 122 may be associated with one or more geographical service areas surrounding the base station. The service areas may be referred to as wireless cells or sectors that are defined by the radio range of a base station 122.

PGW 124 may provide connectivity to external networks, such as public packet network 130 and content delivery network 140. A mobile device 110 may have simultaneous connectivity with more than one PGW 124. PGW 124 may perform, for example, policy enforcement, packet filtering for each user, charging support, lawful interception, and/or packet screening.

MME 126 may act as a control-node for wireless core 120. MME 126 may be responsible for idle mode tracking of mobile devices 110. MME 126 may function in the network bearer activation/deactivation process and may also be responsible for choosing an SGW 128 for a mobile device 110 when the mobile device comes online and at handover of the mobile device. MME 126 may also be responsible authenticating the user of the mobile device. MME 126 may also be the termination point for ciphering/integrity protection for network signaling.

SGW 128 may route and forward user data packets while also acting as the mobility anchor for the user plane during inter radio handovers and as an anchor for mobility between LTE and other technologies. For idle state mobile devices 110, SGW 128 may terminate the data path and trigger paging when data arrives for the idle mobile device 110. SGW 128 may additionally manage and store mobile device 110 contexts, e.g. parameters of the IP bearer service and network internal routing information.

BMSC 170 may each include one or more network or computing devices to, among other functions, allocate and control the allocation of bandwidth in base stations 122. BMSCs 230 may receive requests to allocate bandwidth, for a multicast broadcast. and in response, may allocate bandwidth and/or control base stations 122 to perform the multicast broadcast. BMSCs 230 may also retrieve content items, which are to be broadcast, from content providers 150/160, and transmit the content items to base stations 122. Each BMSC 170 may be associated with one or more base stations 122. Although shown as being implemented externally to wireless core 120, in some implementations, BMSC 170 may be included as part of wireless core 120.

Public packet network 130 may include a public or private (or both) packet-based network. One or more servers may be connected to or located within packet network 130. The servers may provide, for example, video content.

Content delivery network 140 may include a network designed to deliver content to mobile devices 110 through wireless core 120. Content delivery network 140 may include, for example, authentication servers, content servers, and high capacity links optimized to provide multimedia content to mobile devices 110. Content delivery network 140, as with public packet network 130, may be a packet-based network.

Content, such as video content, may be provided by content providers 150 and 160, which may include content servers that may store and transmit content to requesting mobile devices 110. In one implementation, a mobile device 110 may request content through a uniform resource locator (URL) or other reference that links to content maintained by content providers 150 and/or 160.

Although public packet network 130/content provider 150 and CDN 140/content provider 160 are illustrated in FIG. 1 as two separate networks and content providers, that may provide content to mobile devices 110, these networks and content providers may generally be referred to herein as content providers 150/160.

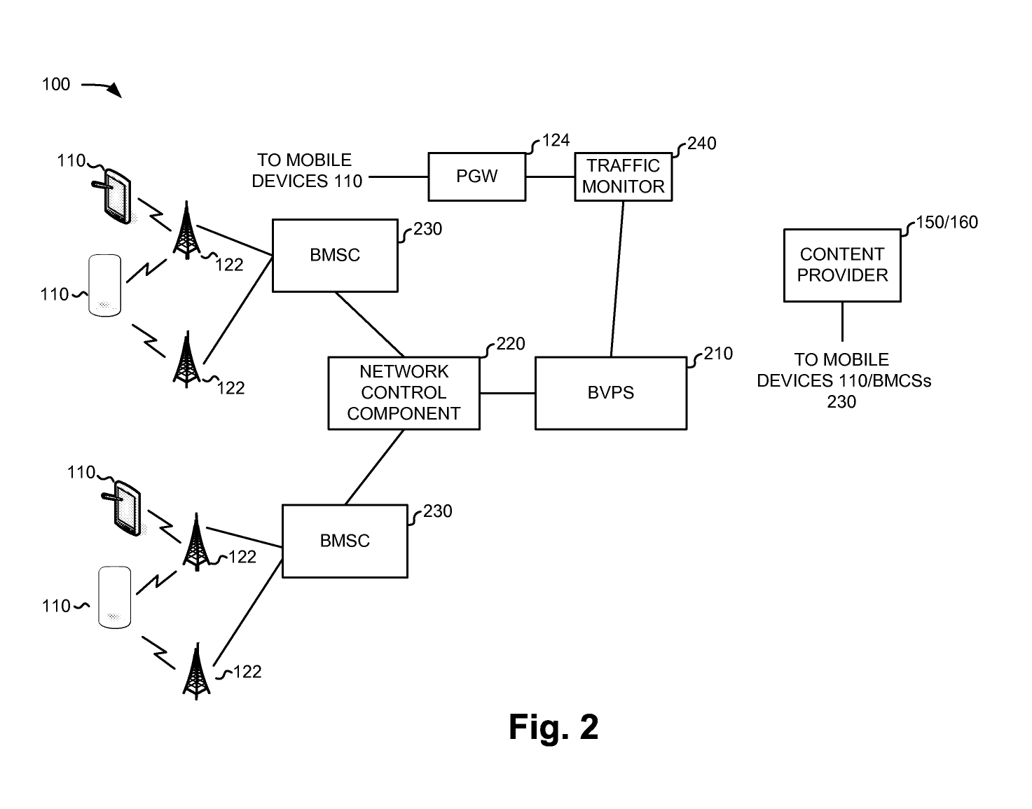

FIG. 2 is a diagram illustrating a second example view of environment 100. In FIG. 2, network elements are illustrated that may relate to an example implementation of techniques described herein. As shown, environment 100 may additionally include: a broadcast video provisioning system (BVPS) 210, a network control component 220, broadband messaging service centers (BMSCs) 230, and a traffic monitor 240. BVPS 210, network control component 220, BMSCs 230, and traffic monitor 240 may each include one or more network elements implemented within one or multiple ones of wireless core 120, public packet network 130, or CDN 140.

BVPS 210 may include one or more network or computing devices to maintain a schedule of content items that are to be broadcast, such as via a multicast MBMS (Multimedia Broadcast and Multicast Service) broadcast, to mobile devices 110. BVPS 210 may also include interfaces through which one or more additional network devices or services may schedule content items to be broadcast. For example, traffic monitor 240 and/or content provider 150/160 may communicate with BVPS 210 to schedule the broadcast of a content item to one or more mobile devices 110. When it is time to deliver a scheduled content item, BVPS 210 may initiate the delivery by signaling network control component 220.

Network control component 220 may include one or more network or computing devices to receive and act upon broadcast requests from BVPS 210. For instance, BVPS 210 may signal network control component 220 to initiate a multicast broadcast. For example, network control component 220 may receive, from BVPS 210, identification of a content item to broadcast and a list of mobile devices 110, base stations 122, and/or geographical regions in which the broadcast should be performed. In response, network control component 220 may reserve network bandwidth, in the radio network, that is required for the broadcast.

BMSCs 230 may correspond to BMSC 170, and each may include one or more network or computing devices to, among other functions, allocate and control the allocation of bandwidth in base stations 122. BMSCs 230 may receive requests to allocate bandwidth, for a multicast broadcast, from network control component 220, and in response, may allocate bandwidth and/or control base stations 122 to perform the multicast broadcast. BMSCs 230 may also retrieve content items, which are to be broadcast, from content providers 150/160, and transmit the content items to base stations 122. Each BMSC 230 may be associated with one or more base stations 122.

Traffic monitor 240 may include one or more network or computing devices to monitor network traffic. Traffic monitor 240 may, for example, examine packet traffic that passes through PGW 124. Traffic monitor 240 may generally provide analytic and network optimization services to network administrators. In one implementation, traffic monitor 240 may monitor traffic from mobile devices 110 for requests for content items, such as video content items available from content providers 150/160. As will be described in more detail below, in response to the determination by traffic monitor 240 that a particular content item is being frequently requested by mobile devices 110, traffic monitor 240 may issue a “trigger” message to BVPS 210 to schedule the multicast delivery of the content item to mobile devices 110.

Although FIGS. 1 and 2 show example components in environment 100, in other implementations, environment 100 may contain fewer components, different components, differently arranged components, and/or additional components than those depicted in FIG. 1. Alternatively, or additionally, one or more components of environment 100 may perform one or more tasks described as being performed by one or more other components of environment 100.

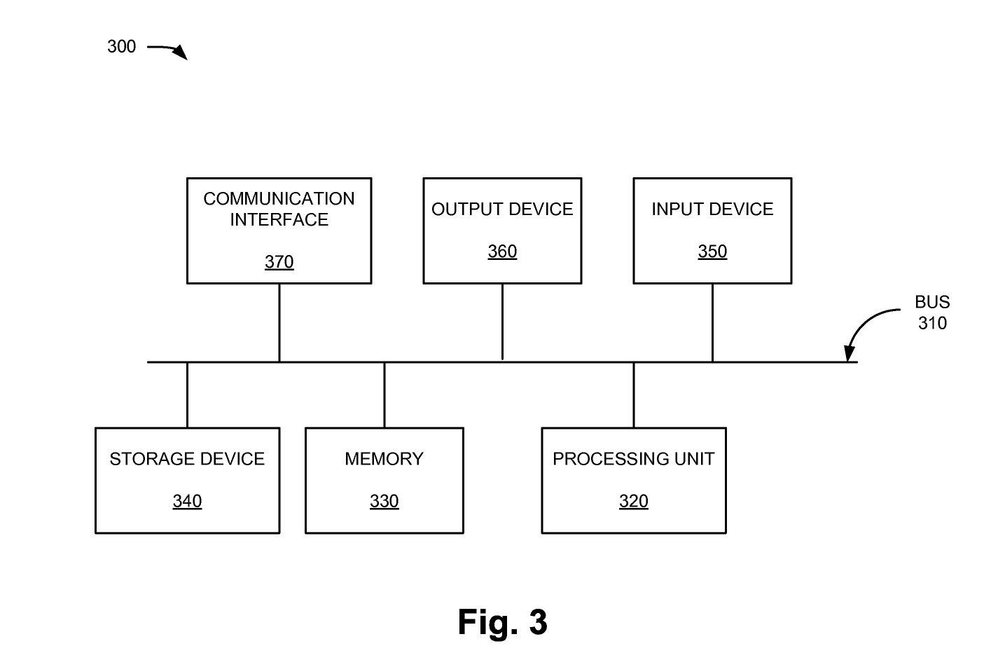

FIG. 3 is a diagram illustrating example components of a device 300, which may correspond to a mobile device 110, a server device used to implement content provider 150/160, BVPS 210, network control component 220, BMSC 230, and/or traffic monitor 240. Alternately, mobile device 110, content provider 150/160, BVPS 210, network control component 220, BMSC 230, and/or traffic monitor 240 may include more than one device 300. As shown in FIG. 3, device 300 may include a bus 310, a processor 320, a memory 330, a storage device 340, an input device 350, an output device 360, and a communication interface 370.

Bus 310 may include a path that permits communication among the components of device 300. Processor 320 may include a processor, a microprocessor, or processing logic (e.g., an application specific integrated circuit (ASIC) or a field programmable gate array (FPGA)) that may interpret and execute instructions. Main memory 330 may include a random access memory (RAM) or another type of dynamic or static storage device that may store information and instructions for execution by processor 320. Storage device 340 may include a magnetic and/or optical recording medium and its corresponding drive, or a removable form of memory, such as a flash memory.

Input device 350 may include a mechanism that permits an operator to input information to device 300, such as a keyboard, a mouse, a button, a pen, a touch screen, voice recognition and/or biometric mechanisms, etc. Output device 360 may include a mechanism that outputs information to the operator, including a display, a light emitting diode (LED), a speaker, etc. Communication interface 370 may include any transceiver-like mechanism that enables device 300 to communicate with other devices and/or systems. For example, communication interface 370 may include mechanisms for communicating with another network device.

As will be described in detail below, device 300 may perform certain operations in response to processor 320 executing software instructions contained in a computer-readable medium, such as memory 330. A computer-readable medium may be defined as a non-transitory memory device. The software instructions may be read into memory 330 from another computer-readable medium, such as storage device 340, or from another device via communication interface 370. The software instructions contained in main memory 330 may cause processor unit 320 to perform processes described herein. Alternatively, hardwired circuitry may be used in place of or in combination with software instructions to implement processes described herein. Thus, implementations described herein are not limited to any specific combination of hardware circuitry and software.

Although FIG. 3 illustrates example components of device 300, in other implementations, device 300 may include additional, fewer, different, or differently arranged components than those illustrated in FIG. 3 and described herein.

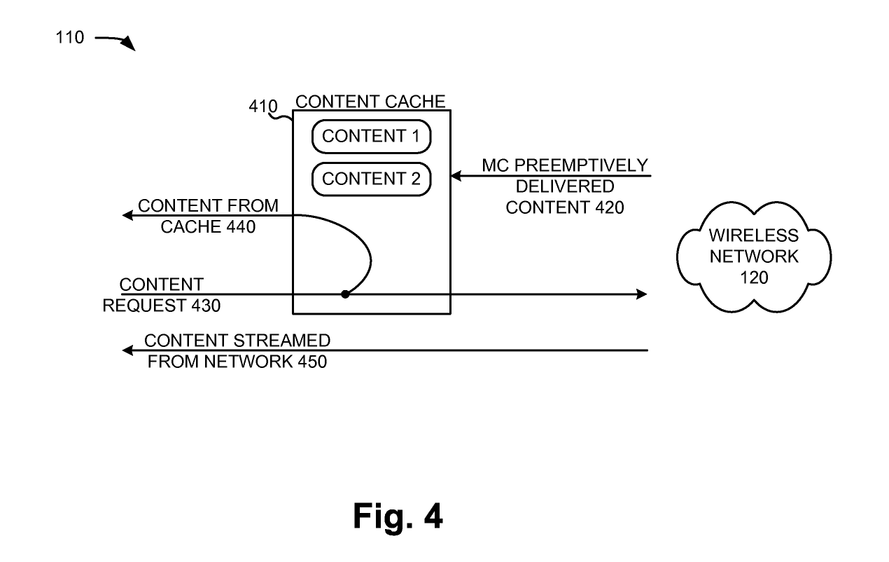

FIG. 4 is a diagram illustrating conceptual components of mobile device 110 relating to the operation of mobile device 110 in caching and presenting content to a user.

As previously mentioned, certain content, such as video broadcasts, may be preemptively delivered to mobile device 110 by multicast delivery of the content over radio interfaces of wireless core 120. Mobile device 110 may include a content cache 410 to store the pre-delivered content. Content cache 410 may include, for example, memory 330/storage device 340 or a portion of memory 330/storage device 340. Two example content items, labeled as “content 1” and “content 2” are illustrated in FIG. 4. The content items may be stored in content cache 410 for potential later viewing by a user of mobile device 410. In some implementations, content cache 410 may be implemented in portions of memory 330/storage device 340 that are unused by other applications associated with mobile device 110.

At certain times, mobile device 110 may receive multicast (MC), preemptively delivered content 420. For example, a content provider 150/160 that provides streaming movies to users may transmit content, such as a popular movie, to a number of mobile devices 110 via multicast. In one implementation, the known MBMS standard may be used to broadcast the content. Through MBMS, multiple mobile devices 110, attached to the cell in which the content is broadcast, may simultaneously receive the content over a shared communication channel. Bandwidth for the radio interface may be conserved relative to a unicast transmission of the content to each mobile device 110.

At some point, a user may request to view content. For example, a user may request to view a video, from content provider 150/160, by submitting content request 430. Content request 430 may include, for example, a resource request (e.g., URL) or other type of request that is submitted, at an application layer of mobile device 110, to content provider 150/160. Mobile device 110 may examine, such as at the operating system layer of mobile device 110, the content request 430, to determine if the requested content is stored in content cache 410.

If the content corresponding to content request 430 can be satisfied from content cache 410, the content may be retrieved from the content cache 410 and presented to the user of mobile device 110. In this situation, content request 430 may be effectively intercepted before it is transmitted to wireless core 120. Thus, content request 430 may be satisfied locally (e.g., at mobile device 110), without requiring additional traffic through wireless core 120 and without latency or bandwidth issues, which may occur when streaming content over a network and which can negatively impact the user experience. The local retrieval of content may be generally transparent to a user of mobile device 110.

If the content is not available in content cache 410, the content request 430 may be forwarded to wireless core 120. The content may then be streamed over wireless core 120, such as from content provider 150/160. The content streaming 450 may be performed, for example, using a unicast streaming operation.

Although FIG. 4 shows example conceptual components of mobile device 110, in other implementations, mobile device 110 may contain fewer components, different components, differently arranged components, and/or additional components than those depicted in FIG. 4.

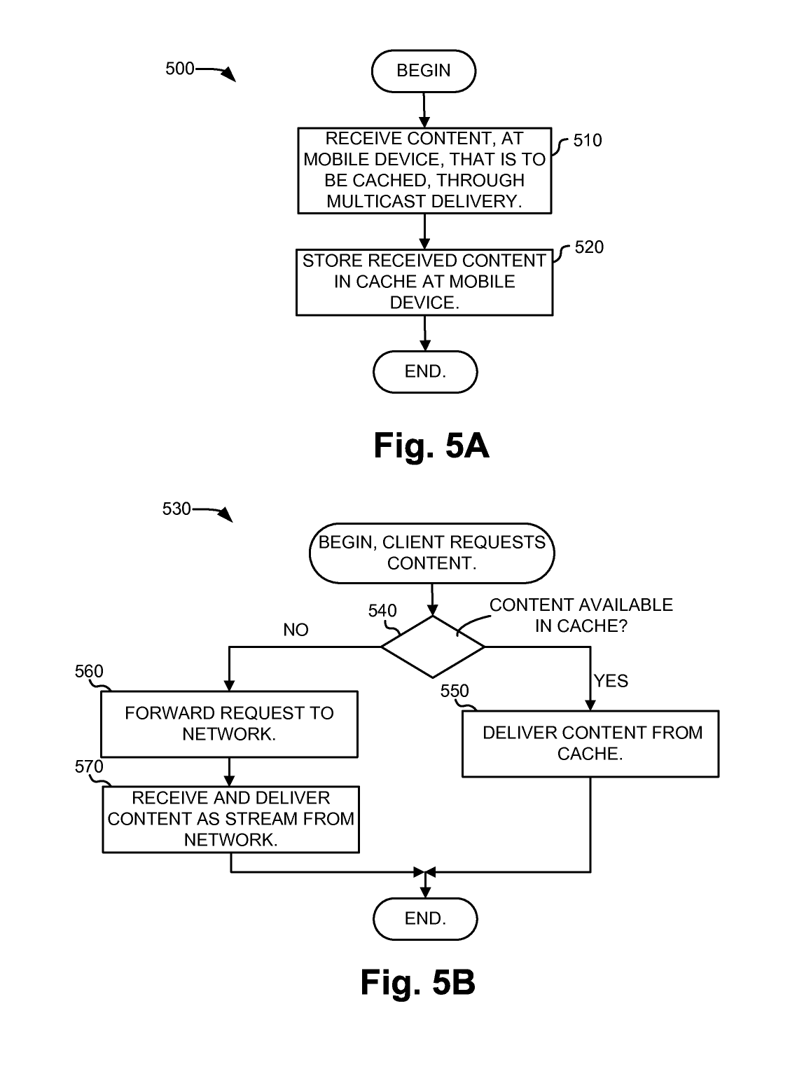

FIG. 5A is a flow chart illustrating an example process 500 for implementing and/or maintaining a content cache at mobile device 110. Process 500, may be performed, for example, by mobile device 110.

Process 500 may include receiving content, over a radio interface of mobile device 110, that is to be cached (block 510). As previously mentioned, the content may be received as a MBMS multicast transmission in which a number of mobile devices, attached to a base station, may simultaneously connect to a certain channel to receive the content. In one implementation, only some active mobile devices 110 may receive a particular content item. For example, if a new video content item is available from a movie provider, only users of mobile devices that are subscribers of the movie provider and that have expressed an interest in the movie may be offered the content. For these mobile devices, the content may be received in the background of the interface of the mobile device, potentially allowing the user to continue uninterrupted use of mobile device 110 while the content item is downloading. As another example, mobile devices in which the battery is low or the signal from wireless core 120 is poor, may refrain from receiving the content.

Process 500 may further include storing the content in the cache (block 520). For instance, content corresponding to a number of video programs, or other content, may be stored in content cache 410. In some implementations, content stored in content cache 410 may be managed so that, when content cache 410 is full, newer content will overwrite older content. In other implementations, other techniques may be used to manage content cache 410.

FIG. 5B is a flow chart illustrating an example process 530 for handling user requests for content at mobile device 110. Process 530, may be performed, for example, by mobile device 110.

Process 530 may begin in response to a user request to view content. For example, through a web browser program or other application, the user may view content that is available for viewing, such as content provided by content provider 150/160. The user may choose a content item to view, and in response, the browser program or other application may submit a request for the content. In one implementation, the available content item may be provided as a link (e.g., a URL), and mobile device 110 may request the content item from the resource referred to by the link (e.g., content provider 150/160).

Process 530 may include determining, in response to the request for the content item, whether the content item is available in the cache (block 540). In one implementation, mobile device 110 may intercept the request for the content item, identify the requested content item from the request, and query content cache 410 to determine whether the content item is available.

When the content item is available in the content cache, (block 540—YES), process 530 may further include delivering the content, from content cache 410, to the user (block 550). Delivering the content may include reading the content from content cache 410 and transmitting the content to the application that submitted the request for the content. From the viewpoint of the application, content delivered from content cache 410 or from wireless core 120 may be handled identically.

In some implementations, digital rights management information associated with the content received from the cache may also be enforced. For example, a particular video that was preemptively downloaded may not be scheduled to be released for viewing until a certain date. Even though the particular video may be downloaded before the date into content cache 410, mobile device 110 may not allow viewing of the particular video until the allowable viewing date.

When the content item is not available in the content cache, (block 540—NO), process 530 may further include forwarding the request, for the content, to wireless core 120 (block 560). The request may be forwarded through PGW 124 to a content provider 150/160, which may respond to the request with the desired content.

Process 530 may further include receiving the content from wireless core 120 as a content stream and delivering the content to the application that requested the content, (block 570), which may then display, or otherwise present, the content to the user.

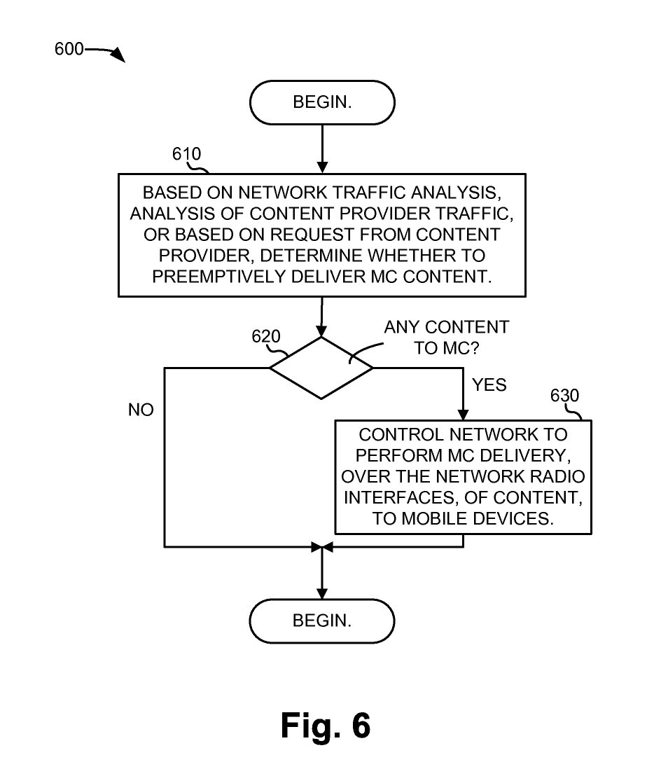

FIG. 6 is a flow chart illustrating an example process 600 for preemptively delivering multicast content to mobile device 110. Process 600 may be performed by one or more devices in environment 100.

Process 600 may include determining, based on network traffic analysis, based on analysis of traffic associated with one or more of content providers 150/160, based on a request from a content provider 150/160, or based on other factors, whether to preemptively deliver, using multicast delivery over the wireless interfaces of base stations 122, content to mobile devices 110 (block 610). In general, the various determinations of whether to preemptively deliver content may be referred to as triggers that are made by various components in environment 100. For example, traffic monitor 240 may determined, based on a passive analysis of traffic through PGW 124, that a particular video content item, provided by one of content providers 150/160, has begun to be frequently requested (i.e., the content item is a relatively popular content item) by mobile devices 110. The term “frequently requested,” in this context, may be determined, for example, by comparison of a number of requests for the content item over a period to a threshold, where the content item may be determined to be frequently requested when the number of requests is greater than the threshold. Traffic monitor 240 may issue a trigger for this content item. As another example, one of content providers 150/160 may analyze logs of requested content items and determine that a particular content item is being frequently requested. The content provider 150/160 may then issue a trigger for this particular content item. As another example, a content provider 150/160 may have a particular content item that is scheduled to be released in the near future or that has just been released. The content provider 150/160 may then issue a trigger for this particular content item.

When content has been identified for preemptive delivery, (block 620—YES), process 600 may include controlling the network to perform multicast delivery, over the radio interfaces of base stations 122, to mobile devices 110 (block 630). In environment 100, for example, as shown in FIG. 2, the content item may be scheduled for delivery, to a number of mobile devices 110, by BVPS 210. At the scheduled delivery time, BVPS 210 may request a multicast MBMS broadcast from network control component 220, which may contact BMSCs 230 to reserve the required network bandwidth. BMSCs 230 may retrieve the content item from content provider 150/160 and control base stations 122 to begin broadcasting the content item. The content item may be broadcast via multicast MBMS delivery so that, for a particular base station 122, multiple mobile devices 110 may simultaneously receive the content item over a single radio channel.

A number of example implementations, using the techniques described above, will next be discussed.

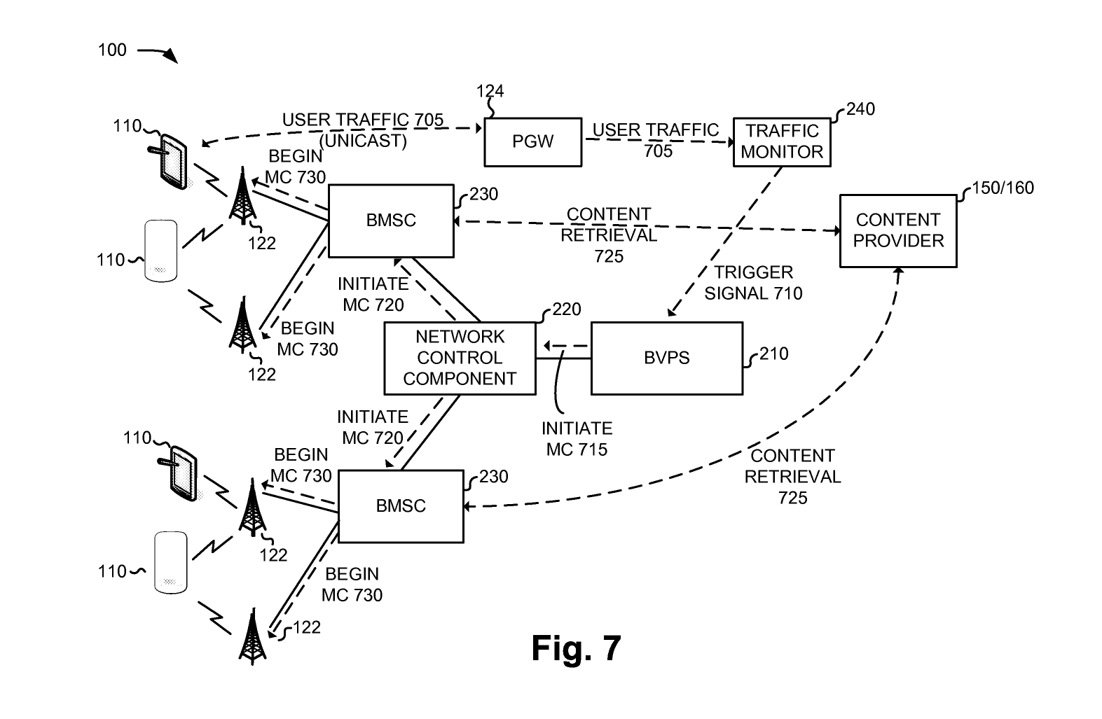

FIG. 7 is a diagram illustrating an example of message communications in environment 100 in the situation in which content is preemptively triggered from traffic monitor 240.

As previously mentioned, traffic monitor 240 may analyze traffic, from mobile devices 110, through PGW 124. The traffic is illustrated as user traffic 705, which may represent data traffic from a number of mobile devices 110. User traffic 705 may be unicast traffic. Traffic monitor 240 may, for example, determine, based on resource requests from a number of mobile devices 110, that a particular content item (e.g., a video) is being frequently requested. The content item may be, for example, a popular user video from a content provider that provides a video download service or a newly released movie from a content provider that provides a movie streaming service.

Assume that traffic monitor 240 determines, based on analysis of user traffic 705, that a particular content item is being frequently downloaded by mobile devices 110. This determination may be made, based on, for example, when a certain threshold number or portion of users request the content item in a certain time period. Traffic monitor 240 may issue a trigger signal 710, to BVPS 210, relating to the content. Trigger signal 710 may identify the content. Trigger signal 710 may include other information, such as indication of the mobile devices 110 that are to preemptively receive the content and/or a preferred time to preemptively deliver the content. In some situations, a content item may be particularly applicable to a certain geographic region or a certain set of users, such as a content item about a regional sports team. In this case, trigger signal 710 may include an indication of the geographic region or set of users for which the content item is relevant.

BVPS 210 may receive trigger signal 710 and may schedule the content item for preemptive delivery to mobile devices 110. When the scheduled delivery time of the content item occurs, BVPS 210 may signal network control component 220 to control wireless core 120 to perform multicast MBMS delivery of the content item (message 715, INITIATE MC). In response to message 715, network control component 220 may signal one or more of BMSCs 230 of the multicast request (messages 720, INITATE MC). BMSCs 230 may also retrieve the content item for the multicast delivery, such as from content provider 150/160 (messages 725, CONTENT RETRIEVAL). BMSCs 230 may then forward the retrieved content item to base stations 122 for multicast delivery (messages 730, BEGIN MC). Base stations 122 may then preemptively broadcast the content item to mobile devices 110, which may store the content item in content cache 410.

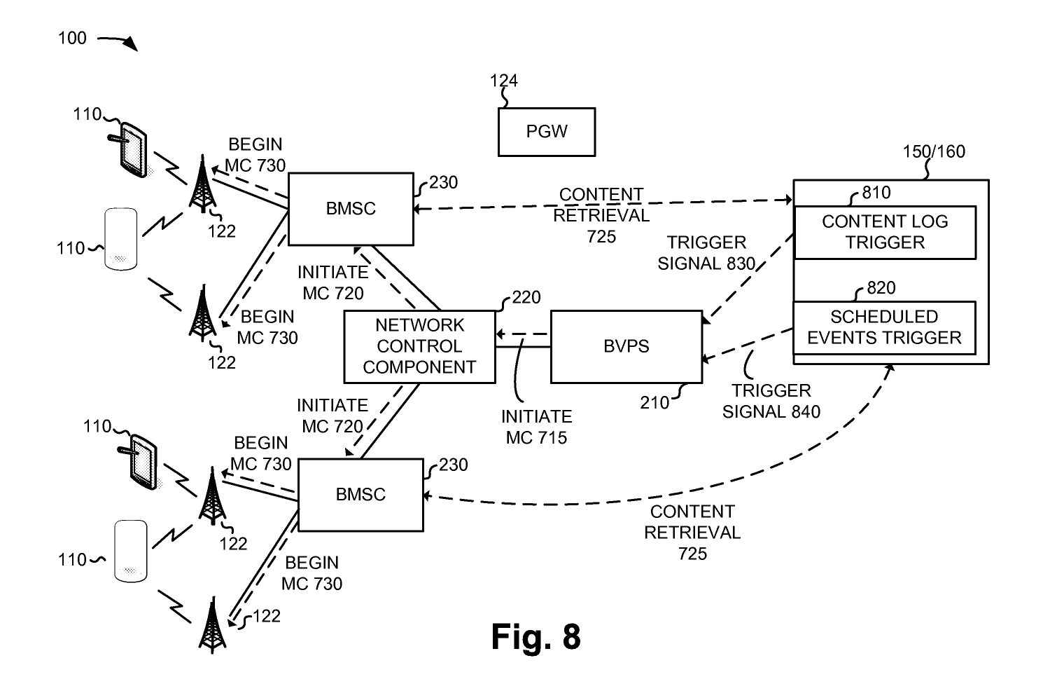

FIG. 8 is a diagram illustrating another example of message communications in environment 100. In this example, preemptive delivery of content is illustrated as being triggered by content provider 150/160. Environment 100, as shown in FIG. 8, may be similar to environment 100, as shown in FIG. 7. However, traffic monitor 240 is not shown in FIG. 8 and content provider 150/160 is shown as including content log trigger component 810 and scheduled events trigger component 820.

Content log trigger component 810 may generate multicast delivery trigger signals, such as trigger signal 830, based on an analysis of historical data, such as logs of past content requests by users of mobile devices 110. For example, assume content provider 150/160 (or a corresponding content delivery network) provides a video streaming service in which users can download videos for viewing. Each user request to view a video may be logged by content provider 150/160. Based on an analysis of the log information, content log trigger component 810 may determine that a video is being frequently requested by the users. For example, a video may be determined to be “frequently requested” when it is download (or otherwise requested) more than a threshold number of times. In response, content log trigger component 810 may issue trigger signal 830 to cause the scheduling of the video for preemptive multicast delivery to mobile devices 110.

Scheduled events trigger component may generate multicast delivery trigger signals, such as trigger signal 840, based on a discretionary trigger. For example, administrators, at content provider 150/160, may decide that a particular video is likely to be frequently downloaded on a certain date. The administrators may initiate the transmission of trigger signal 840 to inform BVPS 210 that the particular video should be scheduled for preemptive multicast delivery before the date. As an example, a popular movie may be released for viewing on a particular date. The administrators may determine that the movie is likely to be a frequently requested download, and may thus request that the movie be preemptively downloaded to mobile devices 110. In this implementation, BVPS 210 may implement an application programming interface (API) that allows certain parties, such as content provider 150/160, to request the scheduling of a content item for preemptive multicast delivery. In this manner, content items that are likely to be popular may be downloaded ahead of time, to mobile devices 110, in a bandwidth efficient manner. In some situations, trigger signal 840 may specify, in addition to the content item that is to be downloaded and information relating to which users are to preemptively receive the content item, digital rights management information, such as the earliest date at which the content item can be viewed at mobile device 110.

It will also be apparent that aspects described herein may be implemented in many different forms of software, firmware, and hardware in the implementations illustrated in the figures. The actual software code or specialized control hardware used to implement aspects described herein is not intended to limit the scope of the invention. Thus, the operation and behavior of the aspects were described without reference to the specific software code—it being understood that software and control hardware can be designed to implement the aspects based on the description herein.

While series of blocks have been described in FIGS. 5A, 5B, and 6, the order of the blocks may vary in other implementations. Also, non-dependent blocks may be performed in parallel.

Even though particular combinations of features are recited in the claims and/or disclosed in the specification, these combinations are not intended to limit the invention. In fact, many of these features may be combined in ways not specifically recited in the claims and/or disclosed in the specification.

Further, certain aspects described herein may be implemented as “logic” or as a “component” that performs one or more functions. This logic or component may include hardware, such as an application specific integrated circuit or a field programmable gate array, or a combination of hardware and software.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise. The scope of the invention is defined by the claims and their equivalents.

What is claimed is:

1. A method implemented by at least one device, the method comprising:
analyzing, by the device, network traffic of a plurality of users;
determining, by the device and based on the analysis, whether a content item is a popular content item, as determined by requests for the content item from the plurality of users; and
transmitting, by the device, a signal, in response to the determination, to schedule preemptive multicast delivery of the content item to a plurality of mobile devices,
where the multicast delivery is performed over one or more radio interfaces in which multiple mobile devices receive the content item over a shared radio channel.

2. The method of claim 1, where the analyzed network traffic includes network traffic at a gateway of a wireless network.

3. The method of claim 1, where the preemptive multicast delivery of the content item includes multicast using Multimedia Broadcast and Multicast Service (MBMS) standard.

4. The method of claim 1, where determining whether a content item is a popular content item includes:
comparing a number of requests for the content item to a threshold.

5. The method of claim 1, where analyzing the network traffic of the plurality of users includes:
analyzing logs, from a content provider, of content requests to the content provider.

6. The method of claim 1, where the analysis of the network traffic is performed based on a passive analysis of the network traffic.

7. The method of claim 1, where the signal includes:
an identification of the content item.

8. The method of claim 7, where the signal additionally includes:
a time to schedule the preemptive multicast delivery;
an indication of a set of mobile devices to receive the preemptive multicast delivery; or
digital rights management information associated with the content item.

9. A device comprising:
one or more processors; and
a memory to store instructions that cause the one or more processors to:
analyze network traffic of a plurality of users;
determine, based on the analysis, whether a content item is a popular content item, as determined by requests for the content item from the plurality of users; and
transmit a signal, in response to the determination, to schedule preemptive multicast delivery of the content item to a plurality of mobile devices;
where the multicast delivery is performed over one or more radio interfaces in which multiple mobile devices receive the content item over a shared radio channel.

10. The device of claim 9, where the analyzed network traffic includes network traffic passing through a gateway of a wireless network.

11. The device of claim 9, where analyzing the network traffic of the plurality of users includes:
analyzing logs, from a content provider, of content requests to the content provider.

12. The device of claim 9, where the analysis of the network traffic is performed as a passive analysis of the network traffic.

13. A system comprising:
a first device, in a network, to transmit a signal in response to a determination, based on an analysis of network traffic from a plurality of users, whether a content item has been requested, by the plurality of users, enough to qualify as meeting a threshold level of popularity; and
a second device, in the network, to receive the signal and, in response to the signal, schedule preemptive multicast delivery of the content item, to a plurality of mobile devices, in a cellular network and over a shared radio channel.

14. The system of claim 13, where the first device includes a traffic monitor component to passively analyze the network traffic at a gateway in a cellular wireless network.

15. The system of claim 13, where the first device includes logic, at a content provider, to analyze logs storing information relating to historical requests of content items.

16. The system of claim 13, where the content items include videos.

17. The system of claim 13, where the signal includes:
an identification of the content item.

18. The system of claim 17, where the signal additionally includes:
a time to schedule the preemptive multicast delivery;
an indication of a set of mobile devices to receive the preemptive multicast delivery; or
digital rights management information associated with the content item.

19. A method implemented by at least one device, the method comprising:
receiving, by the device, a request to schedule preemptive multicast delivery of a content item to a plurality of mobile devices;
scheduling, by the device and in response to the request, multicast delivery of the content item to the plurality of mobile devices; and
communicating, by the device and according to the scheduled delivery, with one or more components of a cellular wireless network, to initiate multicast delivery, using Multimedia Broadcast and Multicast Service (MBMS), of the content item, at a plurality of base stations in the cellular wireless network.

20. The method of claim 19, where the request is received, through an application programming interface (API), from a content provider.

21. The method of claim 19, where the request is received from a traffic monitor component that generates the requests based on analysis of traffic through the cellular wireless network.

22. The method of claim 19, where the request to schedule preemptive multicast delivery includes:
an identification of the content item.

23. The method of claim 22, where the request to schedule preemptive multicast delivery additionally includes:
a time to schedule the preemptive multicast delivery;
an indication of a set of mobile devices to receive the preemptive multicast delivery; or
digital rights management information associated with the content item.
